(19) United States
(12) Patent Application Publication
(10) Pub. No.: US 2007/0230802 A1
(43) Pub. Date: Oct. 4, 2007

(54) Image decoding apparatus

(75) Inventors: Kiyotaka Kato, Tokyo (JP); Ikuro Ueno, Tokyo (JP); Ryuta Suzuki, Tokyo (JP)

Correspondence Address: BIRCH STEWART KOLASCH & BIRCH, PO BOX 747, FALLS CHURCH, VA, 22040-0747, US

(73) Assignee: Mitsubishi Electric Corporation

(21) Appl. No.: 11/501,072

(22) Filed: Aug. 9, 2006

(30) Foreign Application Priority Data
Apr. 3, 2006 (JP) 2006-102041

(51) Int. Cl. G06K 9/36

(52) U.S. Cl. 382/233

(57) ABSTRACT

Provided in an image decoding apparatus including an input unit for inputting a code stream; a low frequency sub-band component decoding unit for decoding a low frequency component; a high frequency sub-band component decoding unit for decoding a high frequency component; a substitute image producing unit for processing the low frequency component decoded image to produce a substitute image; an error detecting unit for detecting an error when a decoding operation is carried out; a timing producing unit for producing a timing signal; a remaining decoding time calculating unit for calculating a remaining decoding time based on both the error detection signal and the timing signal; an output image control unit for controlling to adaptively select an output image based on the error detection signal and the decoding process time signal; and an output image selecting unit for selecting any one of the high frequency component decoded image and the substitute image based on the control operation by the output image control means, and for outputting the selected image as a display image.

### BACKGROUND OF THE INVENTION

1. Field of the Invention

The present invention is related to an image decoding apparatus capable of adaptively switching decoded images when a decoding error of a code stream is detected.

2. Description of the Related Art

In JPEG2000 and image coding algorithm with employment of resolution layers such as wavelet transformation, an input image is processed by means of two-dimensional wavelet transformation, quantizing operation, and entropy coding operation so as to produce a code stream. In the case that an input image (original image) is wavelet-transformed to be sub-band-resolved to a low frequency component (LL component) and a high frequency component, in the resolution of a level 1, the “LL component” becomes such an image obtained by reducing the original image by ½ along a horizontal direction and a vertical direction (¼ in total). For instance, in such a case that an original image owns resolution of 4000×4000 along longitudinal and lateral directions, as a transformed image, an “LL component” becomes an image having resolution of 2000×2000. Also, as high frequency components, an “HL component”, an “LH component”, and an “HH component” are produced. In a decoding apparatus, both a code stream of the “LL component” and a code stream of the “high frequency component” are decoded, and then, the decoded code streams are processed by means of inverse wavelet transformation, so that an image having resolution of 4000×4000 (equal to resolution of original image) may be obtained.

In an image decoding apparatus for decoding a moving picture having high resolution, in the case that an error is mixed in a coded code stream, a decoding error occurs, so that an image output operation is interrupted or disturbed for a time duration until a decoding circuit is recovered from the decoding error. Also, since the moving picture having high resolution is decoded, a real-time process for giving a heavy load occurs. Therefore, in the case processing performance of the decoding circuit cannot sufficiently accept this real-time process and therefore a decoding error occurs, an image output operation is interrupted, or disturbed for a time duration until the decoding circuit is recovered. To avoid this problem, a method has been proposed by which wavelet transforming coefficients having errors within sub-band components which are split to a plurality of components are interpolated, and output images are changed by checking as to whether or not the error is present (refer to, for example, JP 2003-69998 A).

Also, another image decoding apparatus has been proposed. That is, in the image decoding operation based on JPEG2000, while considering temporal restrictions as to time allowable in the image decoding operation, since only an LL component is to be decoded, relatively high image qualities may be maintained even when an image is reproduced in this image decoding apparatus (refer to, for instance, JP 2002-325257 A).

Also, another image decoding apparatus has been proposed in which since LL component→(LH and HL components)→HH component are displayed in a progressive display process, resolution of decoded images is increased (refer to, for instance, JP 2004-40674 A).

Also, another image decoding apparatus has been proposed in which in order to realize a high-speed decoding process, only an LL component is decoded while decoding processes of LH, HL, and HH components are not required if necessary (refer to, for instance, JP 2004-236216 A).

Further, there are other image decoding apparatuses in which in order to reduce processing cost, decoding process of sub-bands other than the LL component are not carried out (refer to, for instance, JP 2002-359846 A, JP 2004-56452 A, and JP 2004-229314 A).

As previously explained, in the conventional image coding apparatus with employment of JPEG2000 capable of handling high resolution moving pictures, or the resolution layer such as the wavelet transformation, when a partial decoding error occurs in a specific resolution layer, there is such a problem that display images corresponding to decoded outputs are interrupted, or disturbed for a time duration until the conventional decoding apparatus is recovered from the decoding error.

Also, in the conventional image decoding apparatus proposed in JP 2003-69998 A when an error is contained in a coded code stream, output switching of the decoded images after error interpolating process has been carried out only based on the presence or absence of the error in the code stream. As a result, there is another problem that display images corresponding to decoded outputs are interrupted or disturbed.

Also, when an error occurs, for instance, in the case that the defined time for executing the real-time decoding process cannot be satisfied due to such a reason that the decoded image owns the high resolution, the output images cannot be adaptively switched in response to the error contents. As a result, there is another problem that display images corresponding to decoded outputs are interrupted or disturbed.

### SUMMARY OF THE INVENTION

The present invention has been made to solve the above-explained problems, and therefore has an object to provide an image decoding apparatus in which even such a case that an error is contained in a code stream or a partial decoding error occurs in a specific resolution layer, the image decoding apparatus can be recovered from the decoding error, while display images corresponding to decoded outputs are not interrupted or disturbed.

According to the present invention, there is provided an image decoding apparatus including: an input means for inputting a code stream which has been coded in a plurality of sub-band components and for resolving the input code stream to obtain a low frequency component code stream and a high frequency component code stream, which are outputted; a low frequency sub-band component decoding means for decoding the low frequency component code stream so as to output a low frequency component decoded image; a high frequency sub-band component decoding means for decoding the high frequency component code stream so as to output a high frequency component decoded image; a substitute image producing means for processing the low frequency component decoded image from the low frequency sub-band component decoding means so as to produce a substitute image; an error detecting means for detecting an error occurred when the high frequency component code stream and the low frequency component code stream are decoded; a timing producing means for producing a timing signal used in a decoding process; remaining decoding time calculating means for calculating a remaining time to perform the decoding process based on an error detection signal from the error detecting means and the timing signal from the timing producing means, and for outputting a decoding process time signal; an output image control means for controlling to adaptively select an output image based on the error detection signal from the error detecting means and the timing signal from the timing producing means; and an output image selecting means for selecting any one of the high frequency component decoded image from the high frequency sub-band component decoding means and the substitute image from the substitute image producing means based on the control operation by the output image control means, and for outputting the selected image as a display image.

In accordance with the present invention, even such a case that an error is contained in a code stream or a partial decoding error occurs in a specific resolution layer, the image decoding apparatus can be recovered from the decoding error, while display images corresponding to decoded outputs are not interrupted or disturbed, since selections of the output images are adaptively switched in response to an error content and a remaining decoding process time.

### BRIEF DESCRIPTION OF THE DRAWINGS

In the accompanying drawings:

FIG. 1 is a block diagram for showing an arrangement of an image decoding apparatus according to Embodiment 1 of the present invention;

FIG. 2 is a flow chart for explaining operations of an output image control means 9 according to Embodiment 1 of the present invention;

FIG. 3 is a block diagram for showing an arrangement of an image decoding apparatus according to Embodiment 2 of the present invention;

FIG. 4 is a flow chart for explaining operations of an output image control means 9 according to Embodiment 2 of the present invention;

FIG. 5 is a block diagram for showing an arrangement of an image decoding apparatus according to Embodiment 3 of the present invention;

FIG. 6 is a flow chart for explaining operations of an output image control means 9 according to Embodiment 3 of the present invention; and

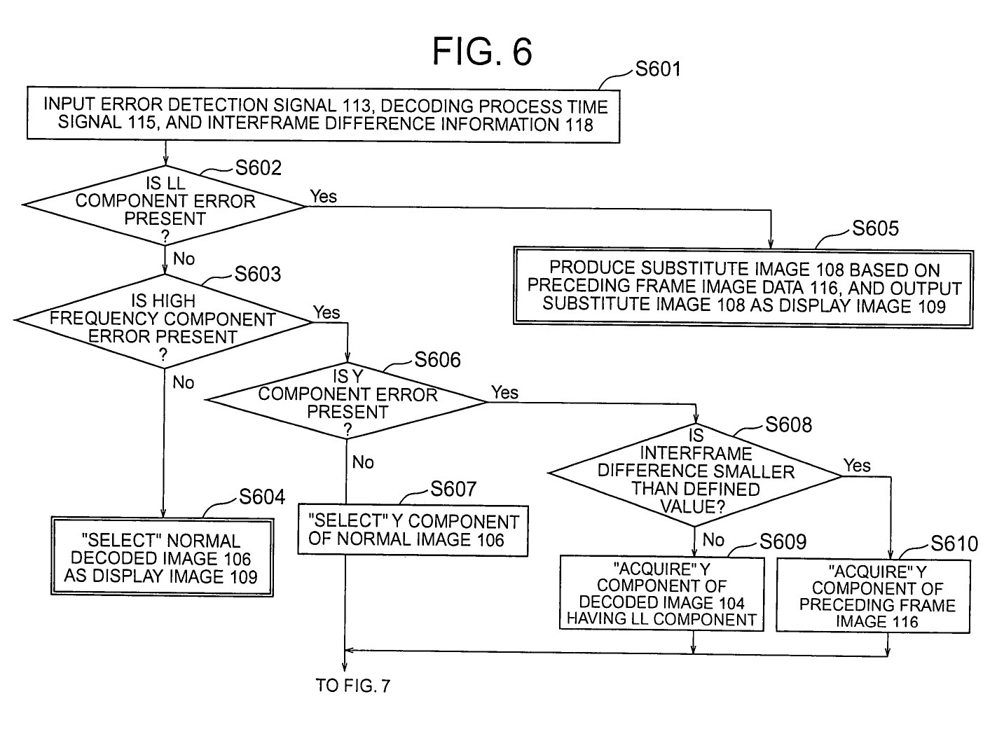

FIG. 7 is a flow chart for explaining operations which are continued to those of FIG. 6.

### DETAILED DESCRIPTION OF THE PREFERRED EMBODIMENTS

### Embodiment 1

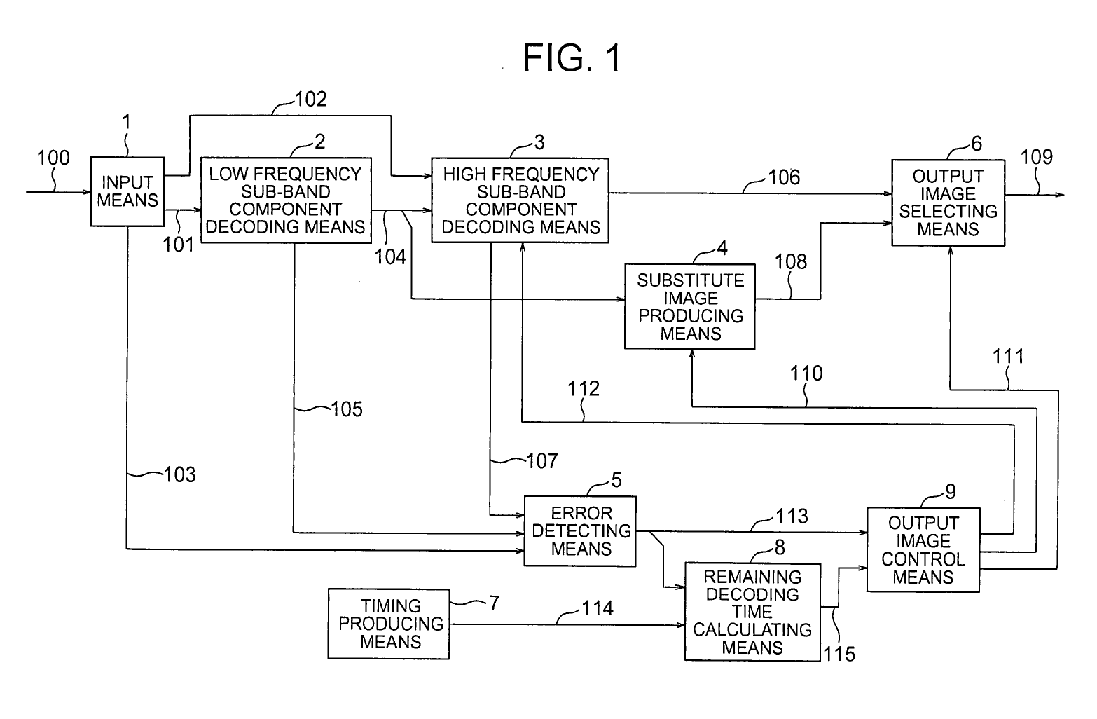

FIG. 1 is a block diagram for showing a configuration of an image decoding apparatus according to Embodiment 1 of the present invention. In FIG. 1, an input means 1 cuts out tag information from package data 100 which is constituted by a code stream coded by JPEG2000 and tag information thereof (metadata), and resolves the code stream constituted by a plurality of frequency components into a low frequency component (LL component) code stream 101 and a high frequency component code stream 102 to output these code streams. Also, the input means 1 outputs an input code stream error status 103 which is acquired from header information and tag information of code streams.

A low frequency sub-band component decoding means 2 decodes an image of the input low frequency component code stream 101 in predetermined resolution to output a low frequency component decoded image 104, and also, to output a low frequency component decoding error status 105 as an error status upon the decoding of the low frequency component.

A high frequency sub-band component decoding means 3 decodes an image in predetermined resolution based on the input high frequency component code stream 102 and the input low frequency component decoded image 104 to output a normal image 106, and also, to output a high frequency component decoding error status 107 as an error status upon the decoding of a high frequency component.

A substitute image producing means 4 produces a substitute image 108 from the low frequency component decoded image 104. An error detecting means 5 outputs an error detection signal 113 based on the input code stream error status 103, the low frequency component decoding error status 105, and the high frequency component decoding error status 107. A timing producing means 7 produces timing which is required in a decoding process, and outputs a timing signal 114.

A remaining decoding time calculating means 8 outputs a decoding process time signal 115 based on the error detection signal 113 and the timing signal 114. An output image control means 9 outputs a substitute image producing signal 110, an output image selecting control signal 111, and a substitute decoding parameter 112 based on the error detection signal 113 and the decoding process time signal 115. An output image selecting means 6 outputs a display image 109 based on the high frequency component decoded image 106 and the substitute image signal 108 in accordance with the output image selecting control signal 111.

Next, operations of the image decoding apparatus will be described. First, the input means 1 inputs package data 100 which is constituted of a code stream encoded by JPEG2000, and tag information (metadata) thereof cuts out the tag information, and then, resolves the code stream constructed of plural frequency components into a low frequency component (LL component) code stream 101 and a high frequency component code stream 102. Further, the input means 1 checks whether or not an error is present in the input code stream by means of the marker check of JPEG2000, and, when there is a marker code which is not defined in JPEG2000, the input means 1 notifies of an error to the error detecting means 5 by the error status 103. The low frequency component (LL component) code stream 101 is decoded by the low frequency sub-band component decoding means 2, and then, is output as a low frequency component decoded image 104 to both the high frequency sub-band component decoding means 3 and the substitute image producing means 4.

The high frequency sub-band component decoding means 3 decodes an image based on both the high frequency component code stream 102 and the low frequency component decoded image 104 in predetermined resolution owned by an original image to output a normal image 106 to the output image selecting means 6. For instance, in the case that the original image is made in resolution of 4096 pixels×4096 lines, a low frequency component decoded image is an image made in resolution of 2048 pixels×2048 lines; and as a decoded result between this image and the high frequency component code stream is inverse-wavelet-transformed, an image having resolution of 4096 pixels×4096 lines which are owned by the original image is decoded. In the case that a decoding error occurs (in case that code which cannot be decoded is contained, or decoding operation cannot be performed due to processing performance), the high frequency sub-band component decoding means 3 sends a high frequency component decoding error status 107 to the error detecting means 5.

When the error detecting means 5 detects an error based on the respective error statuses, the error detecting means 5 outputs the error detection signal 113 to both the remaining decoding time calculating means 8 and the output image control means 9. While the timing signal 114 required in the decoding operation has been input from the timing producing means 7 to the remaining decoding time calculating means 8. When the error detection signal 113 is input, the remaining decoding time calculating means 8 calculate a remaining decoding process time, and if it is judged that the decoding operation can be carried out again by comparing the calculated remaining decoding process time with the defined decoding process time, the decoding process time signal 115 is sent to the output image control means 9.

In order to acquire a remaining decoding time by the remaining decoding time calculating means 8, for instance, in such a case that 24 frames are displayed within one second, a decoding operation for 1 frame must be processed within 1/24 second (namely, 41.17 ms) (in case that plural frame decoding operations are carried out in parallel, time defined by 41.17×total parallel number is allowed). A vertical synchronization signal (frame synchronization signal per 1/24 second) and a horizontal synchronization signal are input as the timing signal 114 from the timing producing means 7. The remaining decoding time calculating means 8 measures an elapse time by an internal clock based on these signals as a reference signal, thereby calculating a time from when the error detection signal 113 is input until the next vertical synchronization signal is input. For instance, if a down counter operable by the reference clock is employed, an initial value of the down counter is set to a value obtained by dividing 41.17 ms by the reference clock time. Then, while the down counter counts down in response to the reference clock, if a value of the down counter at a stage that the error detection signal is input is monitored, this down counter value X the reference clock time may constitute a time duration which is allocated to the remaining process. It should be understood that since defined values for the decoding process time differ from each other depending on decoding process performance, these defined values may be set from an external device such as a CPU to a memory provided in the image decoding apparatus, or may be previously stored in a ROM, or the like.

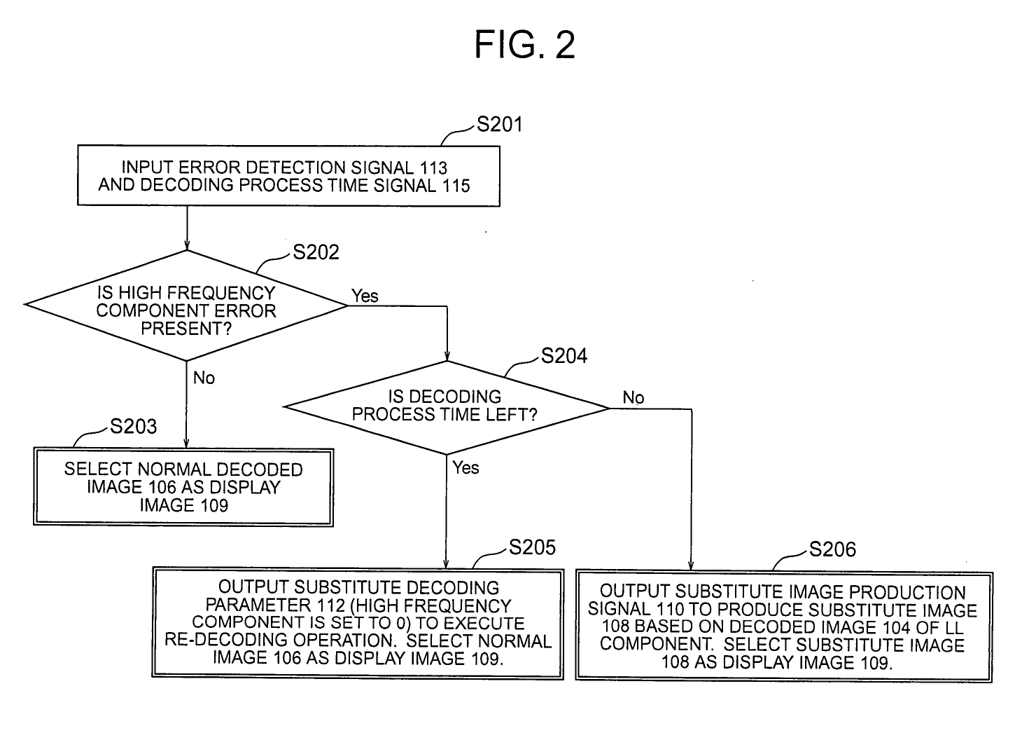

Referring now to a flow chart shown in FIG. 2, operations of the output image control means 9 are described. The output image control means 9 firstly inputs both the error detection signal 113 by the error detecting means 5 and the decoding process time signal 115 from the remaining decoding time calculating means 8 (S201). Then, in the case that an error is not detected by the error detection signal 113 in a high frequency component (“high frequency component error” is “NO”), the output image control means 9 performs the normal decoding process, and then, outputs the output image control signal 111 for performing the normal decoding process to the output image selecting means 6 in order that a normal image 106 is selected by the output image selecting means 6 to be output as a display image 109 (S202→S203).

On the other hand, if the output image control means 9 receives the error of the high frequency component by the error detection signal 113 from the error detecting means 5, the output image control means 9 outputs a substitute decoding parameter 112 to the high frequency sub-band component decoding means 3 so as to cause the high frequency sub-band component decoding means 3 to perform a re-decoding process in such a case that a re-decoding process time is present based on the decoding process time signal 115 from the remaining decoding time calculating means 8 in order that a normal image 106 is selected by the output image selecting means 6 to be output as a display image 109 (S202→S204→S205).

The high frequency sub-band component decoding means 3 re-decodes the high frequency component code stream containing the error based on the substitute decoding parameter 112 as a code stream whose decoded result becomes 0, and performs the inverse wavelet transformation with respect to both the decoded result and the low frequency component decoded image 104 to output the inverse-wavelet-transformed image as the normal image 106 to the output image selecting means 6. The output image selecting means 6 outputs the normal image 106 as the display image 109 in response to the output image control signal 111.

Also, in a case where it is judged that there is not enough re-decoding process time based on the decoding process time signal 115 from the remaining decoding time calculating means 8, the output image control means 9 outputs the substitute image producing signal 110 to the substitute image producing means 4, and also outputs the output image control signal 111 to the output image selecting means 6 in order to select the substitute image 108 as the display image 109 (S204→S206).

The substitute image producing means 4 performs interpolating and filtering with respect to the low frequency component decoded image 104 to produce a substitute image 108 having predetermined resolution, and then, outputs the produced substitute image 108 to the output image selecting means 6. For example, in the case that an original image is made in resolution of 4096 pixels×4096 lines, a low frequency component decoded image having a resolution level 1 is an image made in resolution of 2048 pixels×2048 lines, and by performing the interpolating and the filtering along a horizontal direction and a vertical direction, a decoded image having the resolution of 4096 pixels×4096 lines of the original image is produced as the substitute image 108. The output image selecting means 6 outputs the substitute image 108 as the display image 109 in accordance with the output image control signal 111.

In the above-explained embodiment 1, in the case that the error is detected in the high frequency component by the error detection signal 113, the output image control means 9 outputs the substitute decoding parameter 112 to the high frequency sub-band component decoding means 3, and executes the re-decoding operation with respect to the high frequency component code stream containing the error as such a code stream whose decoded result becomes 0, so that the normal image 106 is obtained. Alternatively, the high frequency sub-band component decoding means 3 may execute the re-decoding operation with the substitute decoding parameter 112 set to 0 as to only any one component having an error among the LH component, the HL component, and the HH component of the above-described frequency components.

Also, as the substitute decoding parameter 112, the re-decoding process is carried out in which the high frequency component is set to 0 to obtain the normal image 106. Alternatively, other proper values may be set to the substitute decoding parameter 112 for the re-decoding operation. Also, instead of carrying out a decoding process with respect to a code stream having an error, a high frequency component having an error may be set to 0, and this high frequency component and other components (LL component and high frequency component having no error) may be processed by the inverse wavelet transformation to acquire a decoded image.

Further, in the above-explained embodiment 1, as the error detection of the code stream, in the case that there is such a marker code which is not allocated to the header information of JPEG2000, this marker code is recognized as the code stream error. Alternatively, since either 1 piece or plural pieces of a check sum, or MIC (message integrity code) of the above-described code stream may be added as metadata into package data to be input, the input means 1 may confirm the completeness thereof in order to judge whether or not the error of the code stream is present.

As explained above, in accordance with Embodiment 1, even when the error is contained in the code stream and even in such a case that the error is detected during the decoding operation, the selections of the output images are adaptively switched according to the error content of the high frequency component of this code stream and the remaining time of the decoding process. As a result, the image decoding apparatus can be recovered from the decoding error, while the display image corresponding to the decoded output is not interrupted or disturbed.

### Embodiment 2

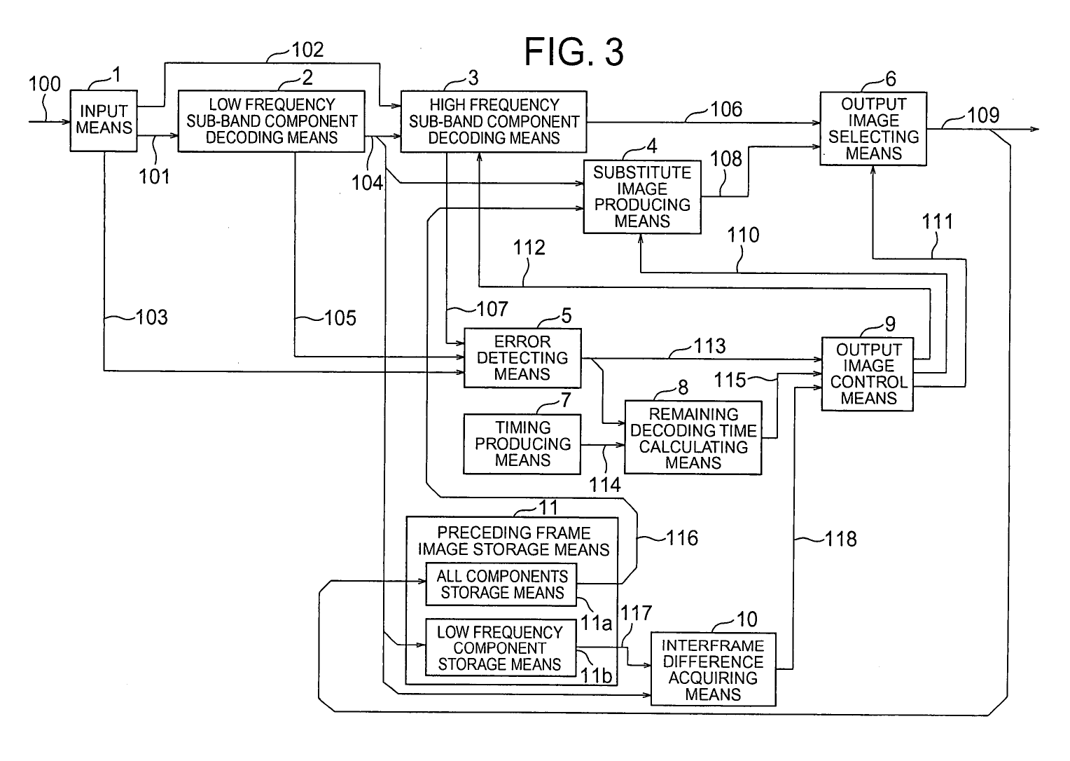

FIG. 3 is a block diagram for showing a configuration of an image decoding apparatus according to Embodiment 2 of the present invention. The same reference numerals shown in Embodiment 1 of FIG. 1 will be employed for the same structural elements in Embodiment 2 shown in FIG. 3, and explanations thereof are omitted. In Embodiment 2 shown in FIG. 3, the image decoding apparatus is further equipped with a preceding frame image storage means 11 for storing an image of a preceding frame, and an interframe difference acquiring means 10 for acquiring an interframe difference between the preceding frame and the present frame. The output image control means 9 controls choice of output images adaptively based on an error detection result of a high frequency component by the error detecting means 5, a result of the remaining decoding time calculating means 8, and a result of the interframe difference acquiring means 10.

In other words, the preceding frame image storage means 11 contains an all component storage means 11a for storing a decoded image of all components of the preceding frame, a low frequency component storage means 11b for storing a decoded image of an LL component of the preceding frame. The preceding frame image storage means 11 outputs a preceding frame decoded image 116 of a frame preceding the present frame by one to the substitute image producing means 4, and further, outputs a preceding frame low frequency component decoded image 117 to the interframe difference image acquiring means 10. The interframe difference acquiring means 10 acquires an interframe difference between a low frequency decoded image 104 of the present frame derived from the low frequency sub-band component decoding means 2 and another low frequency decoded image of a preceding frame derived from the low frequency component storage means 11b, and then, outputs interframe difference information 118. Then, the output image control means 9 outputs a substitute image producing signal 110, an output image selection control signal 111, and a substitute decoding parameter 112 based on the error detection signal 113, the decoding time signal 115, and the interframe difference information 118.

Operations of the image decoding apparatus will be described in the following. First, the input means 1 inputs package data 100 which is constituted of a code stream encoded by JPEG2000, and tag information (metadata) thereof cuts out the tag information, and resolves the code stream constructed of plural frequency components to obtain a low frequency component (LL component) code stream 101 and a high frequency component code stream 102. Further, the input means 1 checks whether or not an error is present in the input code stream by means of the marker check of JPEG2000, and when there is a marker code which is not defined in JPEG2000, the input means 1 notifies of an error to the error detecting means 5 by the error status 103. The low frequency component (LL component) code stream 101 is decoded by the low frequency sub-band component decoding means 2, and then output as a low frequency component decoded image 104 to both the high frequency sub-band component decoding means 3 and the substitute image producing means 4.

Now, in the case that an error happens to occur when the low frequency component code stream 101 is decoded by the low frequency sub-band component decoding means 2, the low frequency sub-band component decoding means 2 notifies of this error via the error detecting means 5 to the output image control means 9 by the low frequency component decoding error status 105. At this time, the output image control means 9 controls to cause the substitute image producing means 4 to produce the substitute image 108 by employing the decoded image 116 of the preceding frame based on the substitute image producing signal 110, and also, controls to cause the output image selecting means 6 to output the substitute image 108 as the display image 109 based on the output image control signal 111.

The high frequency sub-band component decoding means 3 performs inverse-wavelet-transformation with respect to the decoded result of the high frequency component code stream 102 entered from the input means 1, and the low frequency component decoded image 104 derived from the low frequency sub-band component decoding means 2 so as to decode the image in predetermined resolution owned by an original image, and then outputs the normal image 106 to the output image selecting means 6. For instance, in the case that the original image is made of such a resolution of 4096 pixels×4096 lines, a low frequency component decoded image is an image made in resolution of 2048 pixels×2048 lines. As a decoded result of this image and the high frequency component is inverse-wavelet-transformed, an image made in resolution of 4096 pixels×4096 lines which are owned by the original image is decoded. In the case that a decoding error occurs, for example, in case that code which cannot be decoded is contained, and decoding operation cannot be performed due to processing performance, the high frequency sub-band component decoding means 3 sends a high frequency component decoding error status 107 to the error detecting means 5.

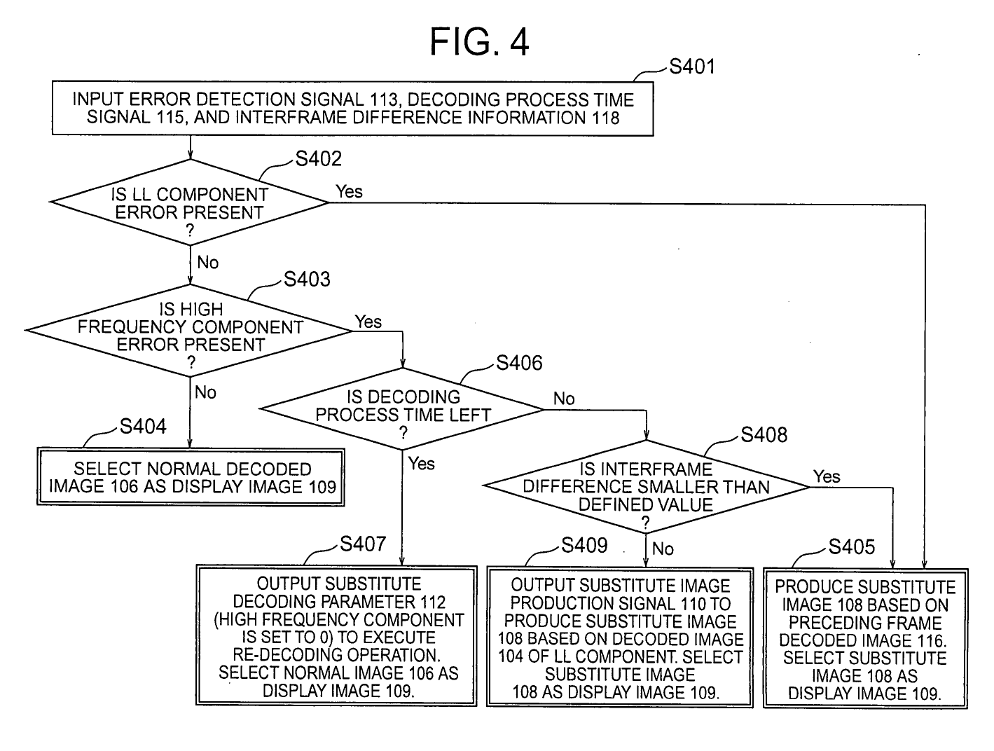

Operations of the output image control means 9 are described with reference to a flow chart shown in FIG. 4. The output image control means 9 firstly inputs the error detection signal 113 from the error detecting means 5, the decoding process time signal 115 from the remaining decoding time calculating means 8, and the interframe difference information 118 from the interface difference acquiring means 10 (S401). Then, in a case that an error is not detected based on the error detection signal 113 from the error detecting means 5, namely, in the case that neither an LL component error nor a high frequency component error are detected, the output image control means 9 performs the normal decoding process, and then, outputs the output image control signal 111 used to perform the normal decoding process on the output image selecting means 6 in order that a normal image 106 is selected by the output image selecting means 6 to be output as a display image 109 (S402→S403→S404).

On the other hand, in the case that there is an error in the low frequency component by the error detection signal 113 from the error detecting means 5, the output image control means 9 outputs a substitute image producing signal 110 to the substitute image producing means 4 in order that the substitute image producing means 4 produces a substitute image 108 by employing the preceding frame decoded image 116, and the produced substitute image 108 is output as the display image 109 by the output image selecting means 6 (S402→S405).

Next, in such a case that the LL component contains no error but the high frequency component contains an error, the output image control means 9 outputs an output image control signal 111 when there is a re-decoding process time based on the decoding process time signal 115 obtained from the remaining decoding time calculating means 8, in order that the substitute coding parameter 112 is output to the high frequency sub-band component decoding means 3 to execute the re-decoding operation, and that the output image selecting means 6 selects the normal image 106 as the display image 109 (S402→S403→S406→S407).

The high frequency sub-band component decoding means 3 re-decodes the high frequency component code stream containing the error as such a code stream whose decoded result becomes 0, and performs the inverse wavelet transformation with respect to both the decoded result and the low frequency component decoded image 104 to output the inverse-wavelet-transformed image as the normal image 106 to the output image selecting means 6. The output image selecting means 6 outputs the normal image 106 as the display image 109 in response to the output image control signal 111.

Also, in such a case that it is judged that there is not enough re-decoding process time based on the decoding process time signal 115 from the remaining decoding time calculating means 8, the output image control means 9 outputs a substitute image producing signal 110 to the substitute image producing means 4, and also, outputs the output image control signal 111 to the output image selecting means 6 in order to perform the following operations: acquiring interframe difference information 118 between the low frequency component decoded image 104 and the preceding frame low frequency component decoded image 117 output from the preceding frame storage means 11 by the interframe difference acquiring means 10; when this interface difference value is smaller than a predetermined value, producing the substitute image 108, for example, as a preceding frame decoded image substitute image by the substitute image producing means 4 by employing the preceding frame decoded image 116; and outputting the produced substitute image 108 as the display image 111 by the output image selecting means 6 (S406→S408→S405).

In this case, the interframe difference acquiring means 10 may calculate, for instance, an average value of absolute difference values between the present frame and the preceding frame as the interface difference information 118:

interframe difference value=(Σ|Xi′−Xi|)/N

i=1˜N, N: pixel number of frame

Xi′: pixel value of present frame, Xi: pixel value of preceding frame

Also, when the interframe difference value is larger than the defined value, the output image control means 9 outputs the substitute image producing signal 110 to the substitute image producing means 4, and further, outputs the output image control signal 111 to the output image selecting means 6 to select the substitute image 108 as the display image 109 (S408→S409).

The substitute image producing means 4 performs interpolating and filtering with respect to the low frequency component decoded image 104 so as to produce a substitute image 108 having predetermined resolution, and then, outputs the produced substitute image 108 to the output image selecting means 6.

Also, the output images from the output image selecting means 6 are stored in the preceding frame storage means 11 at the same time. For instance, in the case that an original image is made in resolution of 4096 pixels×4096 lines, a low frequency component decoded image having a resolution level 1 is an image made in resolution of 2048 pixels×2048 lines, and then, by performing interpolating and filtering along a horizontal direction and a vertical direction with respect to this image, a decoded image having the resolution of 4096 pixels×4096 lines of the original image is produced as the substitute image 108.

It should also be understood that since the defined values which are compared with the interface difference values are different from each other in accordance with gradation numbers of data to be handled, these defined values may be set to, for example, a memory provided in the image decoding apparatus from an external unit by a CPU and the like, or may be previously stored in a ROM, or the like.

In the above-described embodiment 2, in the case that the high frequency component code stream 102 contains the error and there is not enough decoding process time, the interframe difference is calculated, and then, the substitute image 108 is produced based on this calculation result. Alternatively, without calculating the interframe difference, the substitute image 108 may be produced based on the low frequency component decoded image 104 so as to use the produced substitute image 108 as the display image 109. Also, in such a case that the high frequency component code stream 102 contains the error and there is not enough decoding process time, the interframe difference is calculated, and then, the substitute image 108 is produced based on this calculation result. Alternatively, without calculating the interframe difference calculated, the substitute image 108 may be produced based on the preceding frame decoded image 116 so as to use the produced substitute image 108 as the display image 109.

Also, in the above-described embodiment 2, such a code stream all of whose high frequency components become 0 is produced as the substitute decoding parameter 112, and the re-decoding process is carried out to obtain the normal image 106. Alternatively, the re-decoding process may be carried out with the substitute decoding parameter 112 set to 0 with respect only to any one component containing the error among the LH component, the HL component, and the HH component of the above-described high frequency component.

Also, as the substrate decoding parameter 112, the re-decoding process is carried out in which the high frequency component is set to 0 so as to obtain the normal image 106. Alternatively, other proper values may be set as the substitute decoding parameter 112 for the re-decoding operation. Also, while a decoding process is not carried out with respect to a code stream having an error, a high frequency component having an error may be set to 0, and this high frequency component and other components (LL component and high frequency component having no error) may be processed by the inverse wavelet transformation so as to acquire a decoded image.

Further, in the above-explained embodiment 2, as the error detection of the code stream, in the case that there is such a marker code which is not allocated to the header information of JPEG2000 contained in the code stream, this marker code is recognized as the code stream error. Alternatively, since either 1 piece or plural pieces of a check sum, or MIC (message integrity code) of the above-described code stream may be added as metadata into package data to be input, the input means 1 may confirm the completeness thereof in order to judge whether or not the error of the code stream is present.

As explained above, in accordance with Embodiment 2, even in the case that the error is contained in the code stream including a scene change, or even in such a case that the error is detected during the decoding process, the selection of the output images is adaptively switched in response to the error content of the high frequency component of this code stream, the remaining decoding process time, and the interface difference information. As a result, the image decoding apparatus can be recovered from the decoding error, while the display image corresponding to the decoded output is not interrupted, or not disturbed.

### Embodiment 3

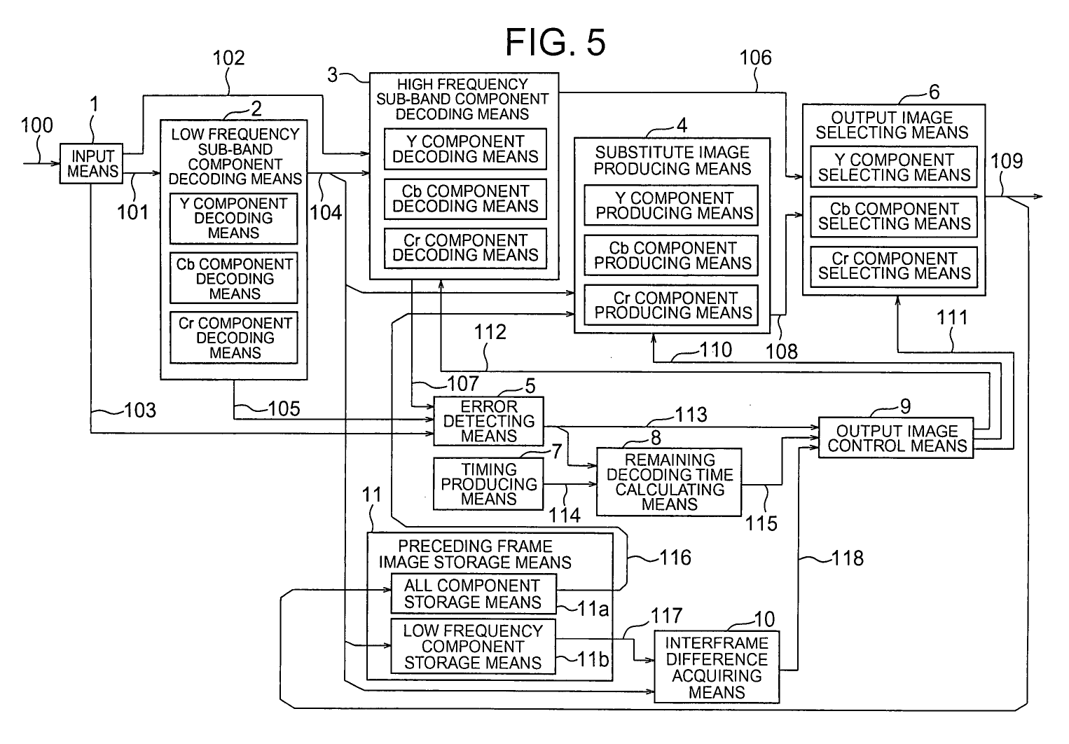

FIG. 5 is a block diagram for showing a configuration of an image decoding apparatus according to Embodiment 3 of the present invention. The same reference numerals as shown in Embodiment 2 of FIG. 3 will be employed for denoting the same structural elements in Embodiment 3 shown in FIG. 5, and explanations thereof are omitted. In Embodiment 3 shown in FIG. 5, a low frequency sub-band component decoding means 2 and a high frequency sub-band component decoding means 3 include a Y component decoding means for decoding a luminance component (Y component) of an image in predetermined resolution, a Cb component decoding means, and a Cr component decoding means, respectively, for decoding color difference components (Cb component and Cr component) of an image in predetermined resolution, respectively. A substitute image producing means 4 contains a Y component producing means, a Cb component producing means, and a Cr component producing means. An output image selecting means 6 contains a Y component selecting means, a Cb component selecting means, and a Cr component selecting means. In the image decoding apparatus of Embodiment 3, an output image is adaptively selected based on an error detection result of color information of a high frequency component contained in a code stream.

In FIG. 5, the low frequency sub-band component decoding means 2 decodes a luminance component (Y component), and color difference components (Cb component and Cr component) of an image which is contained in an input low frequency component code stream 101 in predetermined resolution so as to output a low frequency component decoded image 104, and also a low frequency component decoding error status 105 upon the decoding of the low frequency component. The high frequency sub-band component decoding means 3 decodes a luminance component (Y component), and color difference components (Cb component and Cr component) of an image in predetermined resolution based on the luminance component (Y component), and the color difference components (Cb component and Cr component) which is contained in an input high frequency component code stream 102 and a low frequency component decoded image 104 so as to output a normal image 106, and also a high frequency component decoding error status 107 upon the decoding of the high frequency component.

The substitute image producing means 4 produces a substitute image 108 of each of the luminance component (Y component), and the color difference components (Cb component and Cr component) based on the low frequency component decoded image 104 from the low frequency sub-band component decoding means 2, the substitute image producing signal 110 from the output image control means 9, and the preceding frame decoded image 116 from the preceding frame storage means 11. The output image selecting means 6 outputs a display image 109 containing the luminance component (Y component) and the color difference components (Cb component and Cr component) based on the low frequency component decoded image 104, the normal image 106 corresponding to the decoded image of all of the components, and the substitute image 108 in accordance with the output image selection control signal 111.

Next, operations of the image decoding apparatus will be described. First, the input means 1 inputs package data 100 which is constituted of a code stream encoded by JPEG2000, and tag information (metadata) of this code stream cuts out the tag information, and resolves the code stream constructed of plural frequency components into a low frequency component (LL component) code stream 101 and a high frequency component code stream 102. Further, the input means 1 checks whether or not an error is present in the input code stream by means of the marker check of JPEG2000, and when there is a marker code which is not defined in JPEG2000, the input means 1 notifies of an error status 103 to the error detecting means 5. The low frequency component (LL component) code stream 101 is decoded by the low frequency sub-band component decoding means 2 into Y component, Cb component, and Cr component, respectively, and then output as an LL component decoded image 104 to both the high frequency sub-band component decoding means 3 and the substitute image producing means 4.

Now, in the case that an error happens to occur when the low frequency component code stream 101 is decoded by the low frequency sub-band component decoding means 2, the low frequency sub-band component decoding means 2 notifies of this error via the error detecting means 5 to the output image control means 9 by the low frequency component decoding error status 105. At this time, the output image control means 9 controls to cause the substitute image producing means 4 to produce the substitute image 108 employing the decoded image 116 of the preceding frame based on the substitute image producing signal 110, and also, controls to cause the output image selecting means 6 to output the substitute image 108 as the display image 109 based on the output image control signal 111.

The high frequency sub-band component decoding means 3 decodes the Y component, the Cb component, and the Cr component, respectively, of the image in predetermined resolution owned by an original image based on the input high frequency component code stream 102 and the LL component decoded image 104 so as to output the decoded image components as the normal image 106 to the output image selecting means 6. At the same time, the high frequency sub-band component decoding means 3 sends the high frequency component decoding error status 107 to the error detecting means 5. When an error is detected based on the respective error statuses, the error detecting means 5 outputs the substitute image producing signal 110 to the substitute image producing means 4.

The substitute image producing means 4 produces a substitute image 108 of each of the luminance component (Y component), and the color difference components (Cb component and Cr component) based on the low frequency component decoded image 104, the substitute image producing signal 110, and the preceding frame decoded image 116. The output image selecting means 6 outputs the display image 109 based on the input normal image 106 and the input substitute image 108 in accordance with an output image selecting control signal 111 output from the error detecting means 5.

Operations of the output image control means 9 are described with reference to a flow chart shown in FIG. 4. The output image control means 9 firstly inputs the error detection signal 113 from the error detecting means 5, the decoding process time signal 115 from the remaining decoding time calculating means 8, and the interframe difference information 118 from the interface difference acquiring means 10 (S601). Then, in such a case that an error is not detected based on the error detection signal 113 from the error detecting means 5, namely, in the case that neither an LL component error nor a high frequency component error are detected, the output image control means 9 performs the normal decoding process, and then, outputs the output image control signal 111 used to perform the normal decoding process to the output image selecting means 6 in order that a normal image 106 is selected by the output image selecting means 6 to be output as a display image 109 (S602→S603→S604).

On the other hand, in the case that there is an error in the low frequency component by the error detection signal 113 from the error detecting means 5, the output image control means 9 firstly outputs a substitute image producing signal 110 to the substitute image producing means 4 and the substitute image producing signal to the output image selecting means 6 in order that the substitute image producing means 4 produces a substitute image 108 employing the preceding frame decoded image 116, and the produced substitute image 108 is output as the display image 109 by the output image selecting means 6 (S602→S605).

Next, in the case that the LL component contains no error and the Y component of the high frequency component code stream 102 contains no error, or in such a case that an error is not present when the decoding thereof is carried out, the output image control means 9 outputs an output image control signal 111 in order that the high frequency sub-band component decoding means 3 executes the normal decoding process of the Y component, and also, the output image selecting means 6 selects the Y component of the normal image 106 as the display image 109 (S602→S603→S606→S607).

In the case that an error happens to occur when the high frequency sub-band component decoding means 3 decodes the Y component of the high frequency component (in case that code which cannot be decoded is contained, or code cannot be decoded due to process performance, high frequency component decoding error status 107 is output), and in such a case that an error is present in a code stream in a Y component of a high frequency component entered by the input means 1 (when error is present in Y component of high frequency component under input code stream error status 103), the output image control means 9 compares a defined value with two interframe differences acquired by the interframe difference acquiring means 10 based on the preceding frame low frequency component decoded image 117 and the low frequency component decoded image 104, which is output from the preceding frame storage means 11 (S606→S608).

If the interframe difference values are larger than the defined value as a result of comparison, the output image control means 9 produces a substitute image of the Y component from the Y component of the low frequency component decoded image 104 by performing interpolating and filtering (S608→S609). On the other hand, if the interframe difference values are smaller than the defined value, the output image control means 9 acquires the Y component of the preceding frame decoded image 116 so as to use the acquired Y component as a substitute image of the Y component (S608→S610). The acquired Y component is output to the output image selecting means 6 as the Y component of the substitute image 108. It should also be noted that when the interframe difference values are acquired, the acquiring operation may be carried out based on only the luminance component (Y component) of the low frequency component decoded image, or all components of the low frequency component decoded image.

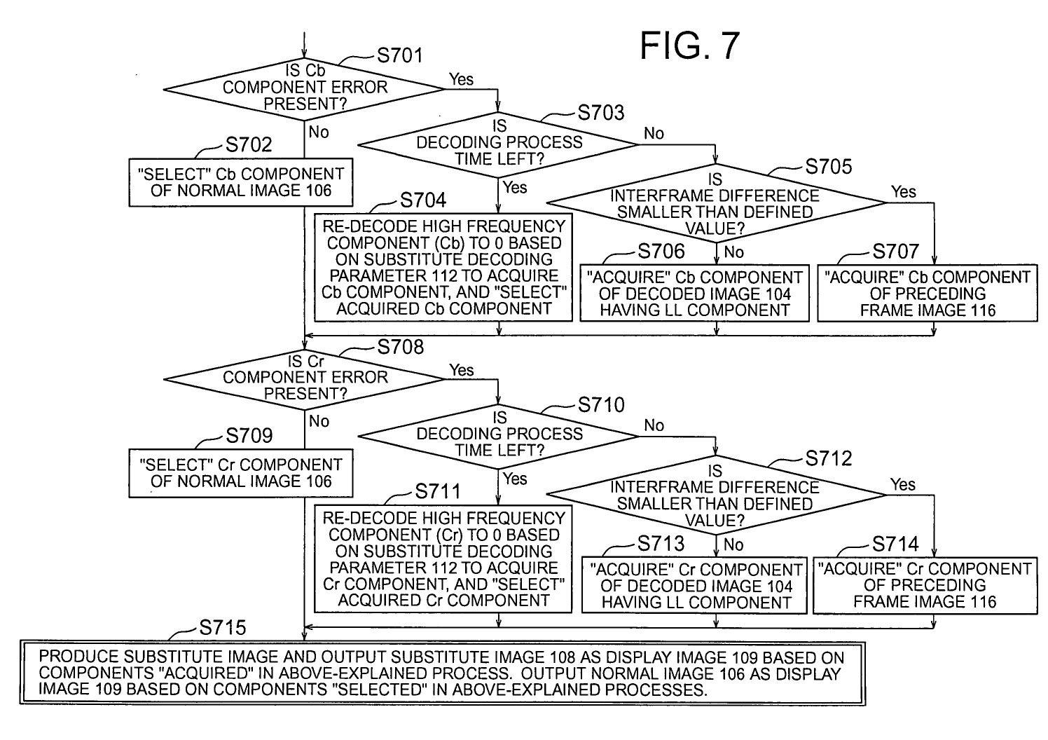

Next, the process moves on to a flow chart of FIG. 7, when the Cb component of the high frequency component code stream 102 contains no error, the output image control means 9 selects the Cb component of the normal image 106 (S701→S702). When the Cb component contains an error produced during the decoding process or a code stream contains an error, the remaining decoding time calculating means 8 acquires such a time that the remaining decoding process from the error occurrence time should be accomplished, and the output image control means 9 determines whether or not a re-decoding process will be carried out (S701→S703). If the decoding process time is left, then the output image control means 9 supplies the substitute decoding parameter 112 to the high frequency sub-band component decoding means 3 (for instance, Cb component of high frequency component is set as 0) so as to execute the re-decoding process and acquire a Cb component of the high frequency component (S703→S704).

On the other hand, in the case that the decoding process time is not left, the interframe difference acquiring means 10 acquires an interframe difference value between the low frequency component decoded image 104 and a low frequency component decoded image 117 of the preceding frame output from the preceding frame storage means 11, and if this difference value is larger than the defined value, the output image control means 9 acquires the Cb component of the low frequency component decoded image 104, and produces a substitute image of the Cb component by performing interpolating and filtering (S703→S705→S706). If the difference value is smaller than the defined value, the output image control means 9 produces a substitute image of the Cb component based on the Cb component of the preceding frame decoded image 116 (S703→S705→S707).

Next, a similar process is carried out also to the Cb component of the high frequency component code stream 102 (S708 to S714), and a similar process is carried out also in such a case that the Cr component of the high frequency component code stream 102 contains an error produced during decoding process, and a code stream contains an error, so that a substitute image of the Cb component is obtained. Among the Y component, the Cb component, and the Cr component of the code stream, components containing no error in a code stream and no error during the decoding operation are subjected to the decoding processes, and are input to the output image selecting means 6. With respect to a component from which an error is detected, a component which is re-decoded selects the normal image 106; such a component that produced the substitute image 108 without the re-decoding operation selects the substitute image 108; and a component which contains no error selects the normal image 106; and then, the selected images are output as the display image 109 and also are stored in the preceding frame image storage means 11.

The component acquired through the above-explained process produces the substitute image, outputs the substitute image 108 as the display image 109, whereas the selected component outputs the normal image 106 as the display image 109 (S715).

It should also be understood that in the above-explained embodiment 3, when the high frequency component code stream 102 contains the error and the decoding processing time is not left, the interframe difference is calculated, and the substrate image 108 is produced by the result. Alternatively, while the interframe difference is not calculated, the substitute image 108 may be produced based on the low frequency component decoded image 104 to be used as the display image 109. Also, in such a case that the high frequency component code stream 102 contains the error and the decoding processing time is not left, the interframe difference is calculated, and the substitute image 108 is produced by this result. Alternatively, while the interframe difference is not calculated, the substitute image 108 may be produced based on the preceding frame decoded image 116 to be used as the display image 109.

Also, in the above-described embodiment 3, such a code stream that all of whose high frequency components become 0 is produced as the substitute decoding parameter 113, and the re-decoding process is carried out so as to obtain the normal image 106. Alternatively, while the substitute decoding parameter 113 may be set to 0 with respect only to any one component containing the error among the LH component, the HL component, and the HH component of the above-described high frequency component of the color difference component and the luminance component (Y component), the re-decoding process may be carried out.

Also, as the substitute decoding parameter 113, the re-decoding process is carried out in which the high frequency component is set to 0 so as to obtain the normal image 106. Alternatively, as to the substitute decoding parameter 113 for the re-decoding operation, other proper values may be set. Also, without carrying out a decoding process with respect to a code stream having an error, a high frequency component having an error may be set to 0, and this high frequency component and other components (LL component and high frequency component having no error) may be processed by the inverse wavelet transformation so as to acquire a decoded image.

Further, in the above-explained embodiment 3, as the error detection of the code stream, in the case that there is such a marker code which is not allocated to the header information of JPEG2000 contained in the code stream, this marker code is recognized as the code stream error. Alternatively, since either 1 piece or plural pieces of a check sum, or MIC (message integrity code) of the above-described code stream may be added as metadata into package data to be input, the input means 1 may confirm the completeness thereof in order to judge whether or not the error of the code stream is present.

Also, the above-explained embodiment 3 has described the luminance component (Y component) and the color difference components (Cb component and Cr component) as the color information of the high frequency component contained in the above-explained code stream. As to color information, if such a stream is constructed by employing an RGB system, then an R component, a G component, and a B component may be alternatively employed. As other color information, a YMCK system, an XYZ system, and a YUV system may be similarly employed.

As previously explained, in accordance with Embodiment 3, even when the error is contained in the code stream and even in such a case that the error is detected during the decoding operation, the productions of the substitute images and the selections of the output images are adaptively switched in response to the error content of the color information such as the luminance component (Y), the color difference components (Cb component and Cr component), or the like of the high frequency component of the code stream which is to be decoded, the remaining time of the decoding process, and the interframe difference information. As a result, the image decoding apparatus can be recovered from the decoding error, while the display image corresponding to the decoded output is not interrupted or disturbed.

What is claimed is:

1. An image decoding apparatus, comprising:
an input means for inputting a code stream which has been coded in a plurality of sub-band components and for resolving the input code stream to obtain a low frequency component code stream and a high frequency component code stream, which are outputted;
a low frequency sub-band component decoding means for decoding the low frequency component code stream so as to output a low frequency component decoded image;
a high frequency sub-band component decoding means for decoding the high frequency component code stream so as to output a high frequency component decoded image;
a substitute image producing means for processing the low frequency component decoded image from the low frequency sub-band component decoding means so as to produce a substitute image;
an error detecting means for detecting an error occurred when the high frequency component code stream and the low frequency component code stream are decoded;
a timing producing means for producing a timing signal used in a decoding process;
a remaining decoding time calculating means for calculating a remaining time to perform the decoding process based on an error detection signal from the error detecting means and the timing signal from the timing producing means, and for outputting a decoding process time signal;
an output image control means for controlling to adaptively select an output image based on the error detection signal from the error detecting means and the timing signal from the timing producing means; and
an output image selecting means for selecting any one of the high frequency component decoded image from the high frequency sub-band component decoding means and the substitute image from the substitute image producing means based on the control operation by the output image control means, and for outputting the selected image as a display image.

2. The image decoding apparatus as claimed in claim 1, wherein:
in the case that an error is not detected in the high frequency component based on the error detection signal from the error detecting means, the output image control means outputs an image selection control signal to the output image selecting means in order to select the high frequency component decoded image from the output image selecting means as the display image;
in the case that an error is detected in the high frequency component based on the error detection signal from the error detecting means, and further, a re-decoding process time is left based on the decoding process time from the remaining decoding time calculating means, the output image control means outputs a substitute decoding parameter to the high frequency sub-band decoding means and outputs an image selection control signal to the output image selecting means in order to cause the high frequency sub-band component decoding means to execute a re-decoding operation, so as to select the high frequency component decoded image from the high frequency sub-band component decoding means as the display image; and
in the case that an error is detected in the high frequency component based on the error detection signal from the error detecting means, and further, a re-decoding process time becomes short based on the decoding process time from the remaining decoding time calculating means, the output image control means outputs a substitute image production signal to the substitute image producing means and outputs an output image control signal to the output image selecting means in order to select the substitute image from the substitute image producing means as the display image.

3. The image decoding apparatus as claimed in claim 1 further comprising a preceding frame image storage means for storing thereinto an image of a preceding frame and interframe difference acquiring means for acquiring an interframe difference between the preceding frame and the present frame, wherein:
the substitute image producing means further produces a substitute image by employing a preceding frame decoded image;
in the case that an error is not detected in both in a low frequency component and a high frequency component based on the error detection signal from the error detecting means, the output image control means outputs an image selection control signal to the output image selecting means in order to output the high frequency component decoded image signal from the high frequency sub-band component decoding means as the display image;
in such a case that an error is not detected in a low frequency component but an error is detected in a high frequency component based on the error detection signal from the error detecting means, and further, a re-decoding process is left based on the decoding process time signal from the remaining decoding time calculating means, the output image control means outputs a substitute decoding parameter to the high frequency sub-band component decoding means and also outputs an image selection control signal to the output image selecting means in order to output the high frequency component decoded image from the high frequency sub-band component decoding means as the display image;
in such a case that an error is not detected in a low frequency component but an error is detected in a high frequency component based on the error detection signal from the error detecting means, a re-decoding process is left based on the decoding process time signal from the remaining decoding time calculating means, and further, the interframe difference from the interframe difference acquiring means is larger than a defined value, the output image control means outputs a substitute image production signal to the substitute image producing means and also outputs an image selection control signal to the output image selecting means in order to select the substitute image from the substitute image producing means as the display image; and
in such a case that an error is not detected in a low frequency component but an error is detected in a high frequency component based on the error detection signal from the error detecting means, a re-decoding process is left based on the decoding process time signal from the remaining decoding time calculating means, and further, the interframe difference from the interframe difference acquiring means is smaller than or equal to the defined value, or in such a case that an error is detected in the low frequency component based on the error detection signal from the error detecting means, the output image control means outputs a substitute image production signal to the substitute image producing means and also outputs an image selection control signal to the output image selecting means in order to select the substitute image as the display image by adopting the preceding frame decoded image from the substitute image producing means.

4. The image decoding apparatus as claimed in claim 1, wherein the output image control means adaptively selects the output image based on an error detection result of color information of the high frequency component contained in the code stream.
